(19) United States
(12) Patent Application Publication
(10) Pub. No.: US 2006/0209676 A1
(43) Pub. Date: Sep. 21, 2006

(54) Network link backup system

(76) Inventor: Kun-Pu Chen, Taipei (TW)

Correspondence Address: RABIN & BERDO, P.C.;Suite 500, 1101 14 Street, N.W., Washington, DC, 20005, US

(21) Appl. No.: 11/080,506

(22) Filed: Mar. 16, 2005

(51) Int. Cl. H04L 12/26

(52) U.S. Cl. 370/216

(57) ABSTRACT

A network link backup system aims to provide network link backup function for electronic equipment (such as a server system, home computer, intelligent home appliance) to maintain normal network operation. The system includes more than one network link module, each including at least one network port, a detection module, a switch unit and a processing module. When the network link module, connected to the electronic equipment, malfunctions, the detection unit generates a control signal to the switch unit, which switches the network path to another backup network link module, to maintain normal network link function of the electronic equipment, thereby enhancing the reliability of the network link of the electronic equipment.

### FIELD OF THE INVENTION

The present invention relates to a network link backup system to provide a backup link for electronic equipment through two or more network link modules.

### BACKGROUND OF THE INVENTION

With increasing popularity of the Internet, the network has become one of the important channels for people to access and retrieve information. Network line speed and quality are vital issues. When electronic equipment is linked, if hardware circuitry breaks down and the electronic equipment cannot be linked to the network, the entire system could be paralyzed. For systems that have critical environment demand such as telecommunications, finances, power plants, dam monitor stations and production lines of most technology companies, system reliability is a critical issue. The network link in electronic equipment aims to maintain high reliability and reduce finance loss, hence the system must be equipped with a fault tolerance function and operate non-stop 24 hours a day, to maintain smooth operation of the network link. In general, if a preset network link breaks down or malfunctions, the electronic equipment cannot perform monitor operation. The network link equipment of the electronic equipment has to be repaired to restore the normal linking operation. But if the entire electronic equipment is shut down simply because the network linking module malfunctions and needs repairs, the resulting disruption is too costly in terms of finance and manpower resource. This is not desirable or acceptable in the present business environment that demands high efficiency.

Therefore, to providing a network link backup system that can provide a backup network link module when the network link module of electronic equipment malfunctions, and maintaining the linking capability of the electronic equipment to enhance the reliability and stability of electronic equipment is a high priority issue in the industry.

### SUMMARY OF THE INVENTION

In view of the aforesaid disadvantages and problems yet to be resolved in the conventional techniques, the primary object of the present invention is to provide a network link backup system that has a backup network link module, switched to perform transformation of the network linking path when a preset network link module malfunctions. Thereby, the primary object is to maintain normal operation of the network link and prevent the linking path from disrupting.

In order to achieve the foregoing object, the network link backup system according to the invention includes at least one network port, a detection unit, a switch unit and a processing module.

One network port is connected to electronic equipment, to link the electronic equipment to a network. Another network port is connected to a backup network link module. The network port is an Ethernet transmission port that may be used in the TCP/IP network transmission protocol or a communication protocol used in optical fiber transmission.

The detection unit aims to detect whether the network link module is in a normal condition, and generates a control signal to the switch unit when the network link module malfunctions, to enable the switch unit to switch to another backup network link module.

The switch unit is located between the network ports and a microprocessor to switch the path of the switched network link according to the control signal generated by the detection unit, and connect another network port of the network link module to another network link module.

The processing module is integrated in a chip set, which is embedded in the network link module to process network link data, transferred from the network port, then transfers to the processor of the electronic equipment.

By means of the network link backup system, when the network link of the electronic equipment malfunctions, it can be switched to the backup network link to maintain linking operation for the electronic equipment, thereby enhancing the reliability and stability of the electronic equipment.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of the invention;

FIG. 2 is a process flow chart of the invention; and

FIG. 3 is a system block diagram of an embodiment of the invention containing two network link modules.

### DESCRIPTION OF THE PREFERRED EMBODIMENTS

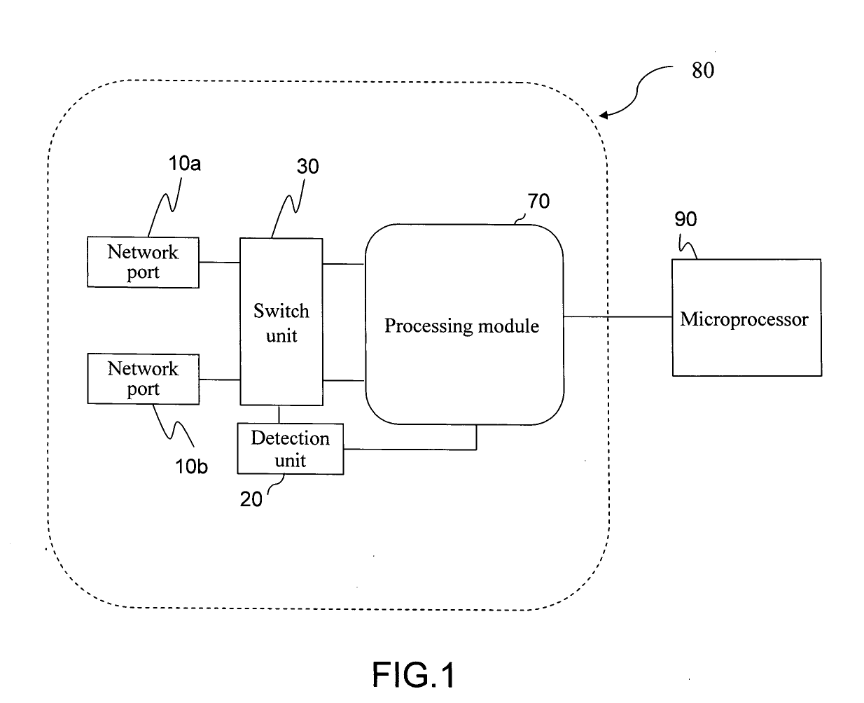

Refer to FIG. 1 for the system block diagram of the invention. It includes network port 10a and 10b, a detection unit 20, a switch unit 30 and a processing module 70 that provide a network backup link function for electronic equipment such as a server system, a home computer, an intelligent home appliance or the like, to maintain normal network link operation.

The network port 10a provides a connection interface for linking the electronic equipment to the Internet, and is a preset main connection interface of the electronic equipment for linking to the Internet. The network port 10a may be an Ethernet port adopting a TCP/IP network transmission protocol or a communication protocol used in optical fiber transmission.

The network port 10b provides a connection interface for linking the electronic equipment to the Internet or another network link module. The network port 10b may be an Ethernet port adopting a TCP/IP network transmission protocol or a communication protocol used in optical fiber transmission. It is preset to link to the connection interface of another network link module here.

The processing module 70 is integrated in a chip set, which is embedded in a network link module 80 to process network link data transferred from the network port 10a or 10b, then transferred to a microprocessor 90 of the electronic equipment.

The detection unit 20 aims to detect data passing through the switch unit 30. If the detected result indicates that the processing module 70 functions normally, the data are transmitted through the network port 10a and processed by the processing module 70, then are transferred to the electronic equipment. If the detection unit 20 detects an abnormal condition, it could be that one element of the processing module 70 malfunctions, and the network link module 80 could have problems. Then the detection module 20 issues a control signal to the switch unit 30 to switch to the network port 10b to continuously receive data from another network link module.

The switch unit 30 is located between the network ports 10a and 10b and the processing module 70. When the network link module 80 is in an abnormal condition, the detection unit 20 generates a control signal to the switch unit 30. The switch unit 30 switches the network port 10a or 10b linked to the electronic equipment according to the control signal generated by the detection unit 20, to connect the electronic equipment to another network link module. The switch unit 30 may be a multiplexer. In FIG. 1, the network port 10a is the preset linking path of the switch unit 30, while the backup linking path is another network port 10b. FIG. 1 shows the condition of two network ports. A similar condition may be adopted for more than two network ports, with one linking to the Internet, while other network ports are linking to a plurality of network link modules. The switch unit 30 can automatically switch to the available network link modules and receive the data processed by the backup network link module.

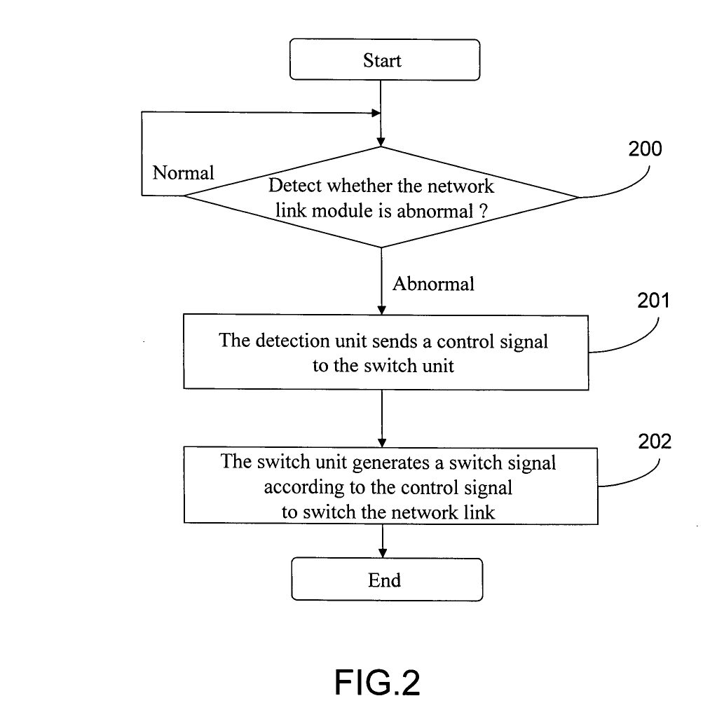

Refer to FIG. 2 for the process flow chart of the detection unit 20 in the system of the invention. Initially a signal is detected and controlled by the detection unit 20. At step 200, the signal is normal, and the detection unit 20 does not issue a control signal, and continuously detects the system. If the signal is abnormal, the detection unit 20 enters step 201 to issue a control signal. At step 202, a switch signal is generated according to the control signal. The detection unit 30 receives the switch signal and switches the network-linking path.

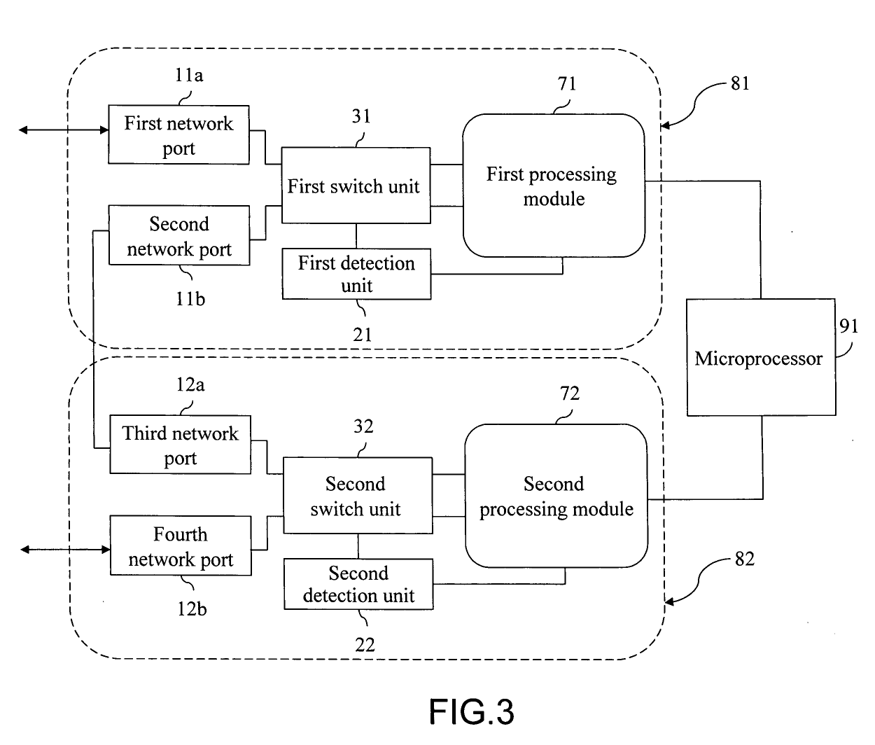

The method previously discussed may be adopted on multiple network link modules. Refer to FIG. 3 for an embodiment of the system block diagram that includes two network link modules. When a first network link module 81 malfunctions, the electronic equipment can be connected continuously to the network through a second network link module 82.

The system block diagram shown in FIG. 3 includes a first network module 81, which consists of a first network port 11a, a second network port 11b, a first detection unit 21, a first switch unit 31 and a first processing module 71. Further, it consists of a second network module 82, which consists of a third network port 12a, a fourth network port 12b, a second detection unit 22, a second switch unit 32 and a second processing module 72. In the first network link module 81, if the first processing module 71 is abnormal in hardware operation, the first detection unit 21 issues a control signal to the first switch unit 31, to activate linking of the second network port 11b. The second network port 11b is connected to the third network port 12a through a network link. After connected, data signals are transmitted from the third network port 12a through the second switch unit 32, and processed by the second processing module 72, and transferred to a microprocessor 91 of the electronic equipment. Thus, to achieve a backup function, network data received by the network port 11a can enter smoothly into the microprocessor 91 of the electronic equipment when the first processing module 71 malfunctions. Similarly, in case the electronic equipment outputs data, the same path for data input is used. First, the second processing module 72 performs processing, and then transfers to the third network port 12a. Then transfers to the second network port 11b through the network, passes through the first switch unit 31 and the first network port 11a, to transmit data from the microprocessor 91 to an external network.

Like the network link module 80 shown in FIG. 1, the first network link module 81 and the second network link module 82 can receive data independently. If the second network link module 82 malfunctions, the electronic equipment can continuously connect to the network through the first network link module 81. When this method is adopted on multiple network link modules, a more stable network link backup for the electronic equipment can be provided. The electronic equipment has to provide insertion slots for installing the multiple network link modules.

By means of the network link backup system set forth above, when the network link of electronic equipment malfunctions, a backup link is provided to switch the network linking path of the electronic equipment to maintain the network connection capability of the electronic equipment. Therefore, the reliability and stability of the electronic equipment or other electronic equipment that requires to be connected to the network is enhanced.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A network link backup system for electronic equipment that consists of at least two network link modules, each of the network link module comprising:
a first network port for connecting the electronic equipment to a network;
a second network port for connecting to another network link module;
a processing module for processing data transferred from the first network port or the second network port;
a detection unit linking to the processing module to detect whether operation of the processing module is normal; and
a switch unit linking to the first network port, the second network port and the processing module to transfer the data to another network link module through the second network port when the operation of the processing module is abnormal.

2. The network link backup system of claim 1, wherein the first network port is an Ethernet transmission port that uses TCP/IP network transmission protocol or a communication protocol used in optical fiber transmission.

3. The network link backup system of claim 1, wherein the second network port is an Ethernet transmission port that uses TCP/IP network transmission protocol or a communication protocol used in optical fiber transmission.

4. The network link backup system of claim 1, wherein the processing module is integrated in a chip set.

5. The network link backup system of claim 1, wherein the switch unit is a multiplexer.

6. A network link backup method for electronic equipment which consists of at least two network link modules, the method comprising the steps of:
receiving network data by a first network port of a network link module;
detecting a processing module of the network link module by a detection unit of the network link module;
issuing a control signal by the detection unit to a switch unit of the network link module when the processing module malfunctions; and
transferring the data received by the first network port through the switch unit and a second network port of the network link module to another network link module which has another processing unit to perform processing.

7. The method of claim 6, wherein the switch unit is connected to a plurality of the network ports.
